(19) United States
(12) Patent Application Publication
(10) Pub. No.: US 2025/0104479 A1
(43) Pub. Date: Mar. 27, 2025

(54) Injection and Other Attacks

(71) Applicant: Jumio Corporation, Sunnyvale, CA (US)

(72) Inventors: Daryl Huff, Saratoga, CA (US); Lei Guang, Montreal (CA); Paras Kapoor, Montreal (CA); Hasmik Martirosyan, Ontario (CA); Alix Melchy, Montreal (CA); Artem Voronin, Montreal (CA); Ervinna Lim Mok, Belmont, CA (US); Stuart Wells, Saratoga, CA (US)

(21) Appl. No.: 18/401,457

(22) Filed: Dec. 30, 2023

Related U.S. Application Data
(60) Provisional application No. 63/585,534, filed on Sep. 26, 2023.

(51) Int. Cl. G06V 40/40; G06T 7/00; G06T 7/73; G06V 10/74; G06V 40/16; G06V 40/70

(52) U.S. Cl. CPC G06V 40/40; G06T 7/0002; G06T 7/74; G06V 10/761; G06V 40/165; G06V 40/172; G06T 2207/20081; G06T 2207/20092; G06T 2207/30176; G06T 2207/30201; G06V 40/70

(57) ABSTRACT

A system and method for receiving, using one or more processors, one or more images associated with a user request, the one or more images including a first image, wherein the first image includes a facial image purported to be that of a valid document holder; determining, using the one or more processors, whether artifacts associated with injection are present in the first image; determining, using the one or more processors, whether a pose in the first image is suspiciously similar to a pose in a second image; and determining whether a background portion in the first image is suspiciously similar to a background portion in another image, wherein the another image was previously received in association with a prior request, wherein the prior request was associated with different document holder data.

### CROSS-REFERENCE TO RELATED APPLICATIONS

This application claims priority, under 35 U.S.C. § 119, to U.S. Provisional Patent Application No. 63/585,534, filed Sep. 26, 2023, and entitled “Synthesized Predicate Driven Index Selection for Partitioned Table” the entirety of which is hereby incorporated by reference.

### BACKGROUND

The present disclosure relates to image capture or processing. More specifically, the present disclosure relates to detecting fraud based on image data.

Facial recognition and comparison are one way of identifying person and verifying a person's identity. For example, providing picture ID may be required to open a financial account to reduce the risk of fraud and/or to comply with laws (e.g., anti-money laundering or sanctions). As another example, an image (e.g., a selfie or video) of the user may be provided to accompany the provided picture ID and be used for a comparison, e.g., to prove the person providing the document is in fact the document holder.

### SUMMARY

The techniques introduced herein overcome the deficiencies and limitations of the prior art, at least in part, with a system and method for multiple fraud type detection using injection or other attacks.

According to one aspect of the subject matter described in this disclosure, a computer-implemented method includes receiving, using one or more processors, one or more images associated with a user request, the one or more images including a first image, wherein the first image includes a facial image purported to be that of a valid document holder; determining, using the one or more processors, whether artifacts associated with injection are present in the first image; determining, using the one or more processors, whether a pose in the first image is suspiciously similar to a pose in a second image; and determining whether a background portion in the first image is suspiciously similar to a background portion in another image, wherein the another image was previously received in association with a prior request, wherein the prior request was associated with different document holder data.

In general, another aspect of the subject matter described in this disclosure includes a system comprising one or more processors and memory operably coupled with the one or more processors, wherein the memory stores instructions that, in response to the execution of the instructions by one or more processors, cause the one or more processors to: receive one or more images associated with a user request, the one or more images including a first image, wherein the first image includes a facial image purported to be that of a valid document holder; determine whether artifacts associated with injection are present in the first image; determine whether a pose in the first image is suspiciously similar to a pose in a second image; and determine whether a background portion in the first image is suspiciously similar to a background portion in another image, wherein the another image was previously received in association with a prior request, wherein the prior request was associated with different document holder data.

Other implementations of one or more of these aspects include corresponding systems, apparatus, and computer programs, configured to perform the actions of the methods, encoded on computer storage devices.

These and other implementations may each optionally include one or more of the following features. For instance, features may also include determining whether artifacts associated with injection are present in the one or more images comprises: training a first model using images including images using a first type of injection, the first type of injection generating first artifacts, and determining that first artifacts are present. For instance, features may also include determining, by applying facial detection, a portion of the first image representing a face, wherein the first model focuses on the portion of the first image representing the face. For instance, features may also include that the first model is injection type specific, the first type of injection is one selected from: a face swap, a face morph, and a synthetic face, and wherein the first artifacts are indicative of the first type of injection. For instance, features may also include determining that the pose in the first image is suspiciously similar to a pose in a second score is based on one or more of a similarity score, a threshold, and a binary classifier. For instance, features may also include that the second image is associated with the user request. For instance, features may also include that the second image was previously received in association with another user request and associated with different document holder information. For instance, features may also include performing a first pose estimation on a face represented in the first image; performing a second pose estimation on a face represented in the second image; comparing the first and second pose estimations; and determining whether the first and second pose estimations satisfy a threshold indicative of suspicious similarity. For instance, features may also include determining a first signature associated with a background portion in the first image; determining another signature associated with a background portion in the another image; and determining, based on the first signature and the another signature, whether the first image and the another image are similar. For instance, features may also include that the first signature and the another signature are both based on one or more of an average hash, a perceptual hash, a difference hash, and a wavelet hash.

The features and advantages described herein are not all-inclusive and many additional features and advantages will be apparent in view of the figures and description. Moreover, it should be noted that the language used in the specification has been principally selected for readability and instructional purposes and not to limit the scope of the techniques described.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of one example implementation of a system for injection-based attack detection in accordance with some implementations.

FIG. 2 is a block diagram of an example computing device in accordance with some implementations.

FIG. 3 is a block diagram of an example injection-based attack detector in accordance with some implementations.

FIG. 4 is an illustration of an example set of images in which the facial image has been reproduced as the document holder image in the document, which may be detected in accordance with some implementations.

FIG. 5 is an illustration of another example set of images in which the facial image has been reproduced as the document holder image in the document, which may be detected in accordance with some implementations.

FIG. 6 is an illustration of an example set of images in which a facial face swap or face morph has been applied to the facial image (selfie) and the document holder image in the document, which may be detected in accordance with some implementations.

FIG. 7 is an illustration of an example set of images in which a facial face swap or face morph, using a different face, has been applied to the facial image (selfie) and the document holder image in the document, which may be detected in accordance with some implementations.

FIG. 8 is an illustration of an example set of facial images (selfies) in which different faces are shown but the background/surroundings are identical, which may be detected in accordance with some implementations. Such facial images may be the result of injection, whether in the form of a real-time face swap, a real-time face morph, or creating the entire image off-line and injecting the facial image into the user device (bypassing the device's native camera hardware and software).

FIG. 9 is an illustration of an example set of images in which the facial image (selfie) is AI generated and the AI generated face is reproduced as the document holder image in the document, which may be detected in accordance with some implementations.

FIG. 10 is an illustration of an example set of images where a nefarious user has used different valid document holder images to modify his face using an injection attack technique (e.g., using a face morph), which may be detected in accordance with some implementations.

FIG. 11 is an illustration of an example of two document image instances that have identical backgrounds, and the document is in exactly the same position suggesting the fraudster imported the whole image and modified the holder image or/and PII data only, which may be detected in accordance with some implementations.

FIG. 12 is an illustration of another example of two document image instances that have identical backgrounds, and the document is in exactly the same position suggesting the fraudster imported the whole image and modified the holder image or/and PII data only, which may be detected in accordance with some implementations.

FIG. 13 is a flowchart of an example method for injection-based attack detection in accordance with some implementations.

FIG. 14 is a flowchart of an example method for pose comparison in accordance with some implementations.

FIG. 15 is a flowchart of an example method for background analysis in accordance with some implementations.

FIG. 16 is a diagram describing an example of camera injection in accordance with some implementations or use cases.

FIG. 17 is an illustration of an example of an injected image and description of example artifacts, which may be detected in accordance with some implementations.

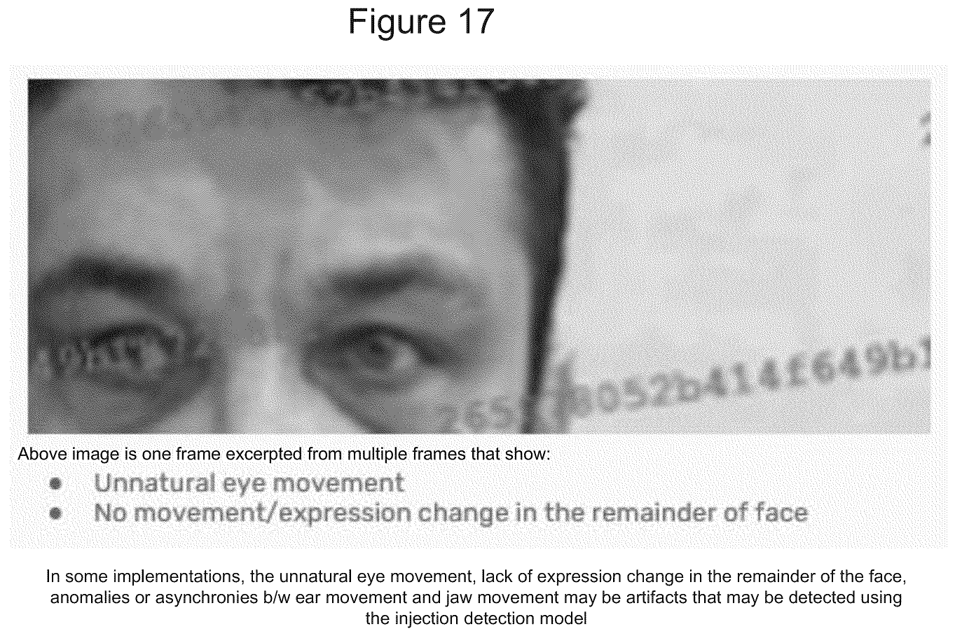

FIG. 18 is an illustration of a selfie and different heatmaps generated that represent focal areas of different machine learning models including an injection detection model in accordance with some implementations.

FIG. 19 is an illustration of an example set of images used to show how background analysis and image segmentation is performed in accordance with some implementations.

### DETAILED DESCRIPTION

The present disclosure is described in the context of an example injection-based attack detector and various example use cases; however, those skilled in the art should recognize that the injection-based attack detector may be applied to other environments and use cases without departing from the disclosure herein. For example, while the present disclosure repeatedly references “injection,” “injection-based attack,” etc., it should be recognized that the system and methods herein may be applied to use cases involving at least some forms of presentation attacks. Examples of presentation attacks include, but are not limited to, presenting a picture (e.g., a printout of previously captured image(s) of the valid document holder), a video (e.g., previously recorded of a legitimate document holder), or a mask (e.g., a photo of the valid document holder cut out and wrapped, or a 3D mask of the valid document holder) instead of a live legitimate subject posing for a selfie. Examples of injection attacks include, but are not limited to, injecting fraudulent image data, e.g., by using a virtual camera, hacking an API or SDK, switching the payload (e.g., image or video) whilst in transit, etc. Additionally, injection attacks may inject images using a presentation attack method. This disclosure presents a series of methods used individually or together to detect sophisticate fraud that is presented to the verification system either directly or injected into the system.

Facial comparison, e.g., between a physical document with an image of the valid document holder and the person physically presenting the document, is a method of determining an individual's identity. This manual task has been performed by bank tellers at a bank counter, bouncers at bars, law enforcement at traffic stops, and in countless other physical environments.

Increasingly, transactions are being performed remotely or electronically, e.g., online through web browsers or mobile applications. Obtaining documentation remotely or electronically and using them to identify individuals presents challenges, which are not present when a person physically presents the documentation in the physical world. When a person physically presents the documentation in the physical world, the document may be manipulated in order to find, view, and extract information from the document. In a remote or electronic transaction, direct physical manipulation and viewing of the physical document is not feasible. When a person physically presents the documentation in the physical world, the person presenting the document may be physically/visually inspected to determine whether the physically present individual is the same individual that appears in the document holder image. In a physical environment, where the person and document are physically present, the burden on a nefarious user to commit fraud and escape detection may be relatively high. The user must (1) Obtain a valid document whose holder resembles him/her closely enough to satisfy the human document reviewer, (2) alter their face (e.g., using prosthetics, a mask, or plastic surgery) to resemble the valid document holder, or (3) replace the document holder's image on a valid document instance with his/her own image, or (4) make a convincing document with the nefarious user's image. Therefore, the nefarious user in the physical world may need a high degree of luck, skill, or commitment (e.g., in the case of undergoing plastic surgery) to successfully pass a physical identity verification using a photo ID and the user's physically present face, and their ability to make repeated unsuccessful attempts is limited (e.g., because the fake ID may be confiscated and the user physically apprehended on the spot).

By contrast, users with nefarious intent (e.g., criminals, fraudsters, money launderers, etc.) may repeatedly attempt to trick the systems and methods used to verify documentation or identity in remote and electronic environments with much less risk of apprehension and, in some cases, little additional effort for each additional attempt. It is sometimes the case that the more times a fraudster (or other nefarious user) is able to attempt fraud, the more likely the fraudster is to eventually succeed in defeating the verification mechanisms. Therefore, detection of repeated fraudulent attempts may be used in identifying and preventing future, potentially successful, fraudulent attempts. However, criminals including fraudsters are resourceful and may not use identical instances of a document or image of a document.

Advances in technologies have decreased the burden on nefarious users and increased the difficulty of preventing fraud in remote and electronic transactions, particularly at scale. For example, image manipulation software (e.g., Adobe's Photoshop) has allowed users to quickly and easily manipulate and create different versions of documents or images thereof, such as fake IDs with different images or information in the various fields such as name. The fraudster may print out or electronically submit the various versions of the fraudulent (e.g., doctored) documentation and use the various versions in a series of attempts to successfully commit fraud. Alternatively, development kits and injectors may allow a fraudster to perform an injection attack. In an injection attack, the nefarious user injects a fake or manipulated facial image into a digital image stream, e.g., a digital image stream associated with the selfie and subsequently the document image to defeat the verification mechanisms, e.g., those verification mechanisms that may be present during a customer onboarding process. The injection may be performed by one or more of using a virtual camera, hacking the verification vendor's application program interface (API) or software development kit (SDK), or by switching the image payload in transit. The injected image may modify a facial image (e.g., by morphing the facial features to be more similar to those in a document holder image) or replace a facial image (e.g., a face swap in which the document holder's face overlays the nefarious user's face). Injection attacks including deepfakes may be generated using a variety of mechanisms, e.g., generative adversarial network-based (“GAN-based”) synthetic faces, diffusion model-based synthetic faces, auto-encoder-based methods, etc. Depending on the attack and use case, the injected facial image may be of a human, a modified image of a human face, or an entirely artificial/synthetically generated face.

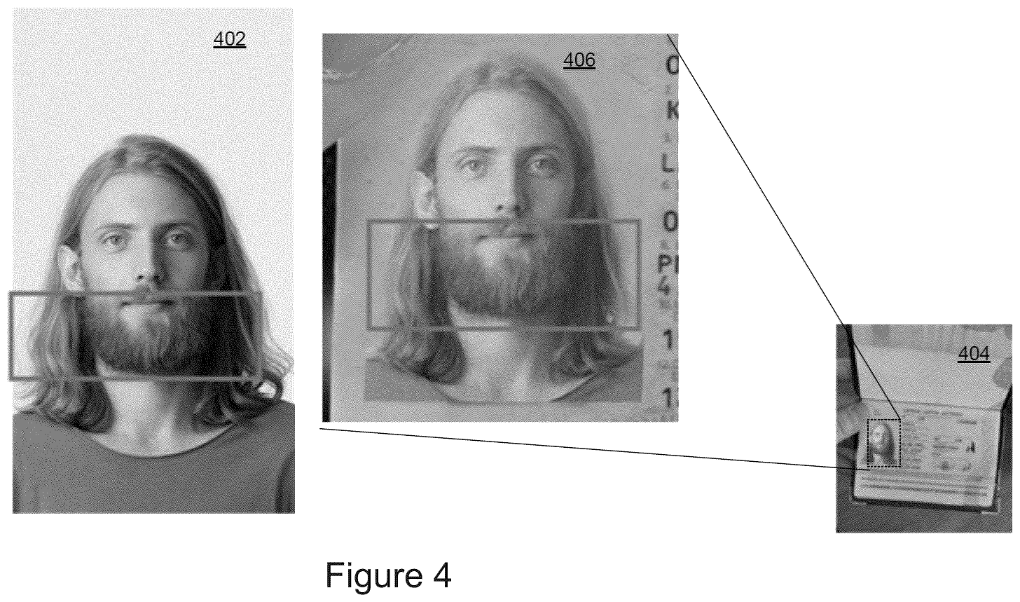

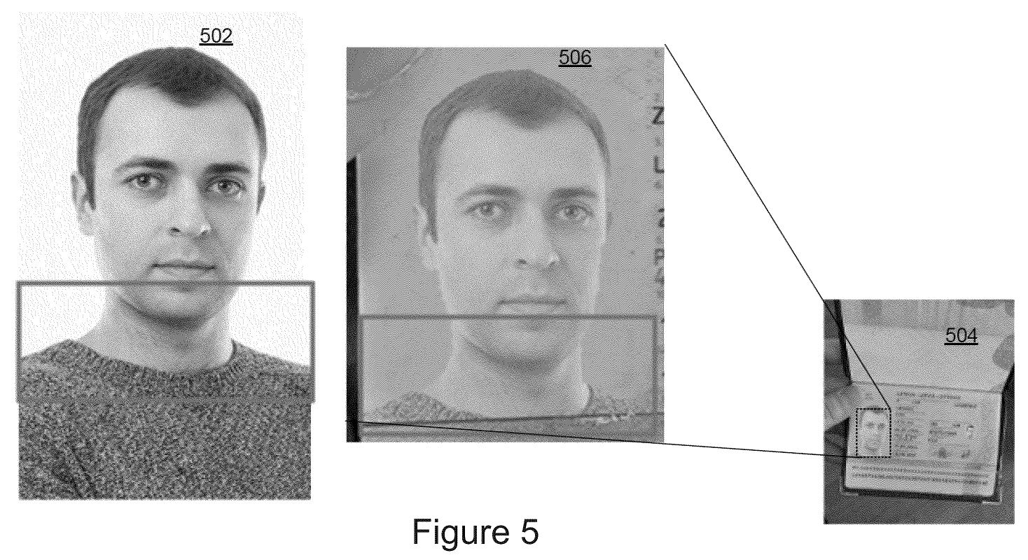

A nefarious user may electronically modify the document holder image to match a real selfie (e.g., using photoshop or injection). For example, referring to FIGS. 4, 5, and 9 the faces from the selfie images 402, 502, and 902 are reproduced in the document holder images 406, 506, and 906, respectively. In FIGS. 4 and 5, the selfie images 402 and 502 and corresponding document holder images 406 and 506, respectively, have the same expressions, hair (head and facial hair in the same length and styled, curling, or falling in the same way), pose, clothing and wrinkles in clothing (as far as it can be seen in the document holder images 406 and 506). It should be understood that the likelihood of a user taking a selfie where such features are identical, or match almost perfectly, is small. For example, even if the user was wearing the same shirt, the wrinkles, drape of the cloth, neckline would vary at least slightly between the passport photo and the selfie. As another example, posing with an identical head position is nearly impossible, even if one were to try. The presence of (close) matches between multiple features is extremely unlikely absent reproduction or modification; therefore, the detection of multiple (close) matches may be indicative of fraud. In FIGS. 4 and 5, it is possible the selfies 402 and 502 may be real/genuine. However, those selfie images 402 and 502 have been copied and modified to produce the document holder images 406 and 506, respectively.

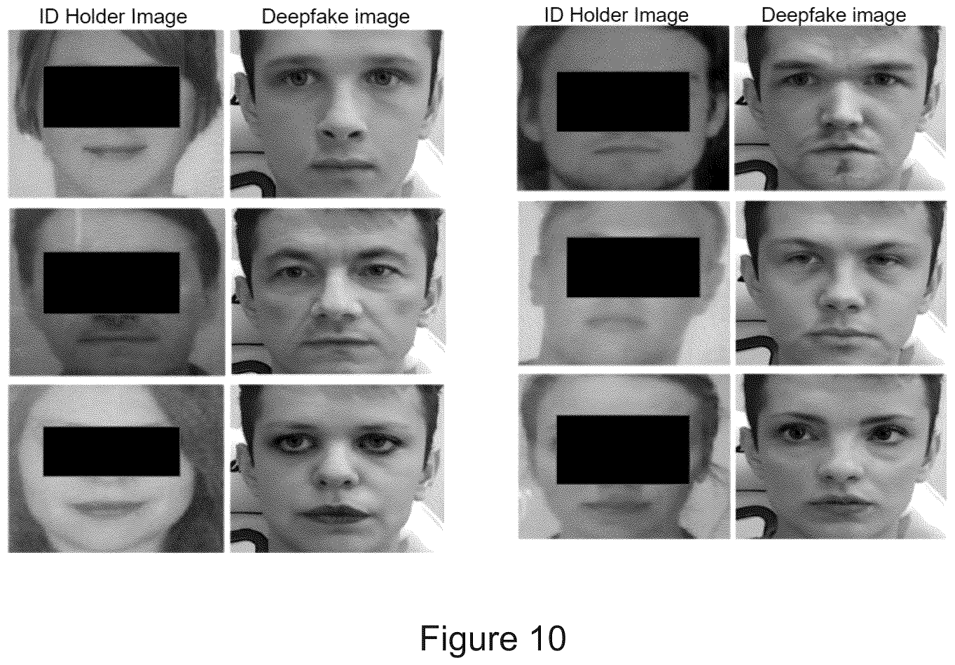

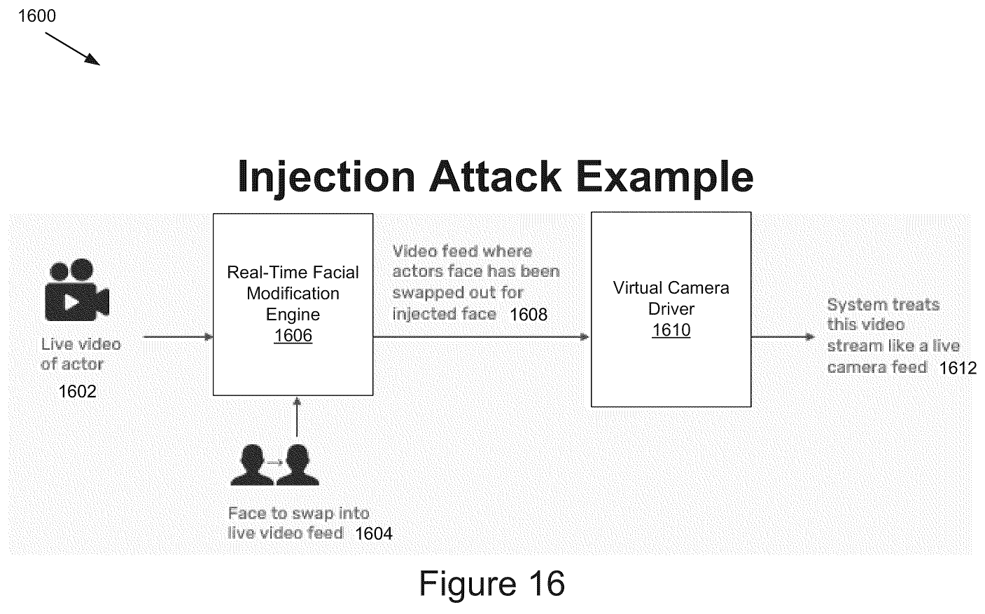

A nefarious user may electronically modify a real (unseen by others and/or the injection-based attack detector 226 or its subcomponents) selfie of himself/herself with a face swap or face morph to match a real document holder image. For example, a nefarious user used injection to face swap, or overlay, a valid document holder's face from a valid ID instance over his/her own face in a selfie that is submitted for comparison to the document holder's image. Additionally, face swaps and morphs are not limited to single/still images, but advances in technology allow modification of video, in real-time in some instances. Referring to FIG. 16, an example diagram of an injection attack is illustrated. In the illustrated example, the injection attack is a deepfake in which a nefarious user obtains and provides, at 1604, a video of a legitimate document holder into the real-time facial modification engine 1606. However, injection may be based on a still image rather than a video in some use cases. In the illustrated example injection scenario, the nefarious user also provides live video of himself/herself to the real-time facial modification engine 1606. The real-time facial modification engine 1606, depending on the implementation, may swap/overlay the document holder's face onto the nefarious user's face in real-time to provide an output video feed at 1608. Alternatively, in some implementations, rather than swapping or overlaying the valid document holders face, the real-time facial modification engine 1606 may modify or morph the nefarious user's face to resemble the document holder's face more closely. Referring to FIG. 10, a series of images showing examples where a nefarious user has morphed an image of the nefarious user (not shown) to make his facial features more similar to those of various, valid document holder's facial image (left) and the resulting deepfake image (right). Referring again to FIG. 16, the video feed with the injected face, output at 1608, is then input to a virtual camera driver 1610, which passes off the video feed as though it is a live, unaltered video feed captured by a camera.

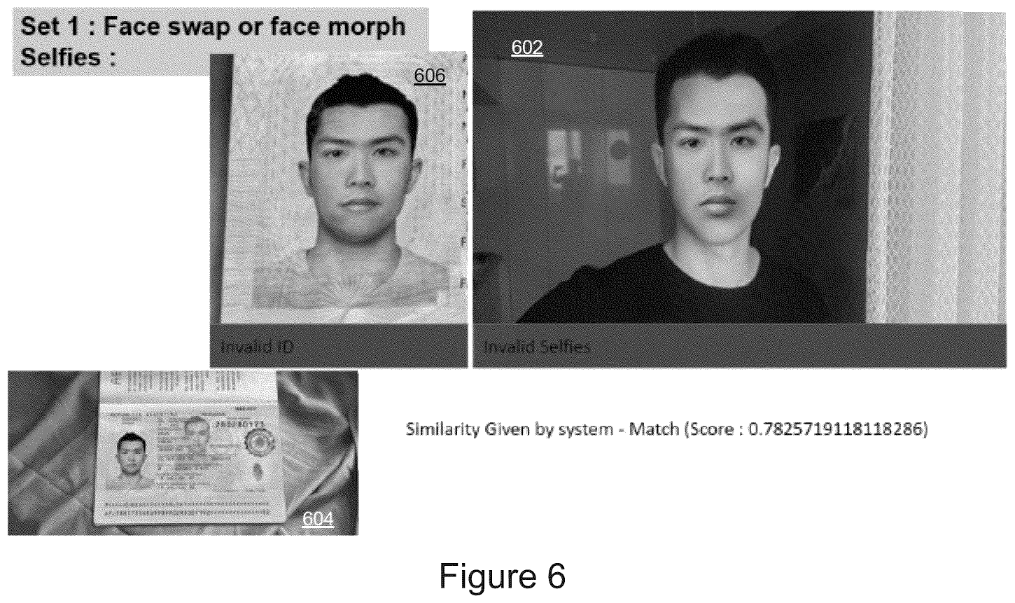

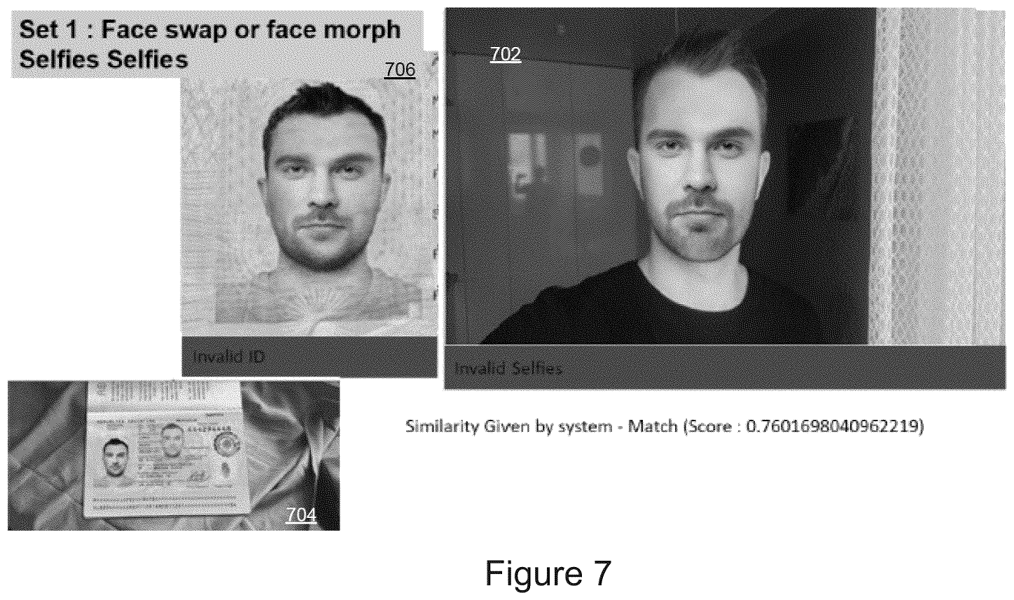

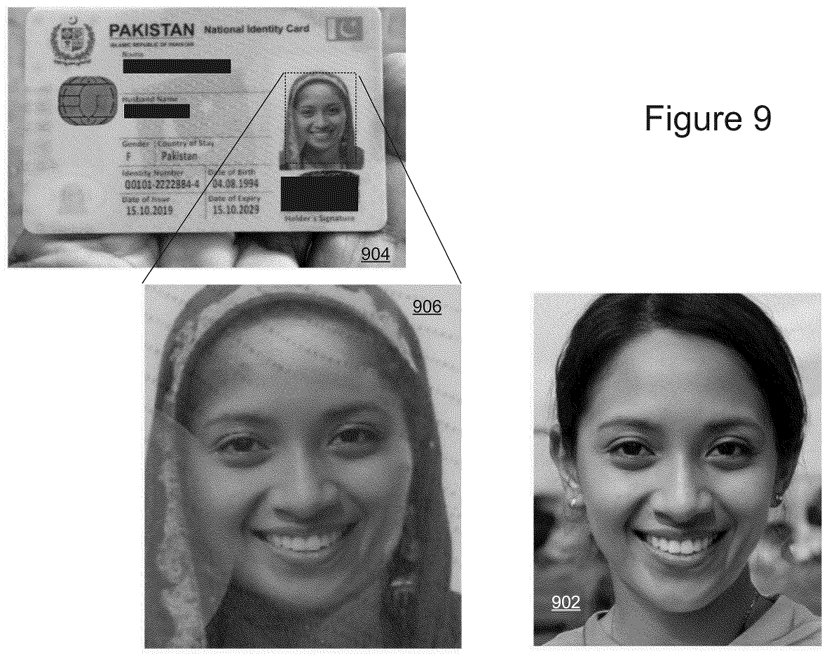

A nefarious user may use generative AI to generate a user image for the selfie and copy the facial image into the document holder image and ghost image (if present in the document). For example, referring to FIG. 9, the selfie image 902 is entirely computer generated including the face, clothing, and background. The face is also reproduced in the document holder image 906 of the identification document in document image 904. As another example, FIGS. 6 and 7 illustrate instances where a nefarious user has used injection to take an original facial image (not shown) and swapped or morphed that face into the selfie image (or video frame) 602/702 and corresponding document holder image 606/706.

To complicate fraud detection and thwart fraud attacks, such as injection attacks, the tools used by fraudsters/nefarious users is relatively inexpensive (e.g., free in some cases), high-quality (i.e., sophisticated and may generate convincing likenesses), and simple (i.e., no programming or special skills may be necessary), thereby expanding the pool of potential nefarious users, the number of potential fraudulent attacks, and the quality of the fraudulent attempts (perhaps not even discernable by a human eye in some cases).

A nefarious user who repeatedly attempt to commit fraud may not use completely distinct documents or images of documents across his/her multiple attempts. For example, the fraudster uses a first instance of a document, then modifies the name, then modifies the date of birth and ID number, and so on, but there will be commonalities between the attempts. Examples of commonalities may include, but are not limited to, the document's surroundings or background; the facial image; the issuer of the ID; the size, orientation, or position of the document in the image; etc. Referring across FIGS. 4-8 and 10-12, examples of multiple document images and multiple facial images (e.g., selfies) are shown with similar, or identical, backgrounds. As another example, the user may perform injection on the same selfie or may generate a series of injected selfies (i.e., selfies generated using injection serially during a single session so that the nefarious user's background, clothes, etc. are similar, but may not be identical). Identifying repeated fraudulent attempts that use similar, but not identical images, presents a challenge. For example, existing methods using hashes may determine identicality, but not similarity that does not rise to the level of identicality.

The injection-based attack detector 226 described herein may address, at least in part, one or more of the issues and/or provide, at least in part, one or more of the benefits described herein.

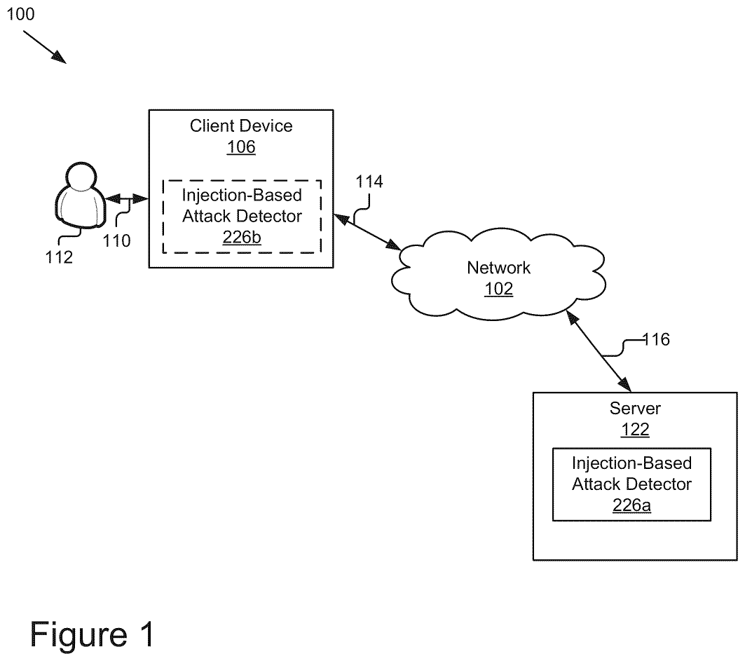

FIG. 1 is a block diagram of an example system 100 for injection attack detection in accordance with some implementations. As depicted, the system 100 includes a server 122 and a client device 106 coupled for electronic communication via a network 102.

The client device 106 is a computing device that includes a processor, a memory, and network communication capabilities (e.g., a communication unit). The client device 106 is coupled for electronic communication to the network 102 as illustrated by signal line 114. In some implementations, the client device 106 may send and receive data to and from other entities of the system 100 (e.g., a server 122). Examples of client devices 106 may include, but are not limited to, mobile phones (e.g., feature phones, smart phones, etc.), tablets, laptops, desktops, netbooks, portable media players, personal digital assistants, etc. In some implementations, injections may take place on a client device 106 (e.g., a mobile phone, tablet, or laptop) and be injected via an API or in transit.

Although only a single client device 106 is shown in the example of FIG. 1, there may be any number of client devices 106 depending on the implementation. The system 100 depicted in FIG. 1 is provided by way of example and the system 100 and further systems contemplated by this present disclosure may include additional and/or fewer components, may combine components and/or divide one or more of the components into additional components, etc. For example, the system 100 may include any number of client devices 106, networks 102, or servers 122.

The network 102 may be a conventional type, wired and/or wireless, and may have numerous different configurations including a star configuration, token ring configuration, or other configurations. For example, the network 102 may include one or more local area networks (LAN), wide area networks (WAN) (e.g., the Internet), personal area networks (PAN), public networks, private networks, virtual networks, virtual private networks, peer-to-peer networks, near field networks (e.g., Bluetooth®, NFC, etc.), cellular (e.g., 4G or 5G), and/or other interconnected data paths across which multiple devices may communicate.

The server 122 is a computing device that includes a hardware and/or virtual server that includes a processor, a memory, and network communication capabilities (e.g., a communication unit. The server 122 may be communicatively coupled to the network 102, as indicated by signal line 116. In some implementations, the server 122 may send and receive data to and from other entities of the system 100 (e.g., one or more client devices 106).

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

For example, as depicted, the client device 106 may optionally (as indicated by the dashed lines) include an instance of the injection-based attack detector 226b and the server 122 may include an instance of the injection-based attack detector 226a. However, in some implementations, the components and functionality of the injection-based attack detector 226 may be entirely client-side (i.e., at 226b), entirely server side (i.e., at 226a), or divide among the client device 106 and server 122 (i.e., divided across 226a and 226b). For example, as described below, some implementations may use machine learning (e.g., one or more algorithms to train one or more models), and the training and validation of the model(s) may be performed server-side at 226a and applied, during production, client side at 226b.

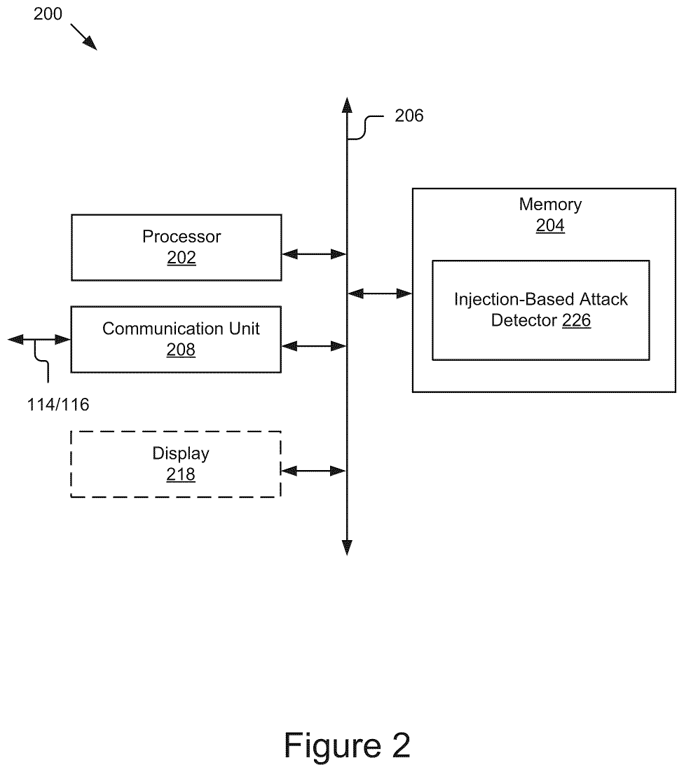

FIG. 2 is a block diagram of an example computing device 200 including an instance of the injection-based attack detector 226. The injection-based attack detector 226 which may refer to either instance 226a when the computing device 200 is a server 122, 226b where the computing device 200 is a client device 106, or a combination of 226a and 226b where the functionality is divided between 226b of the client device 106 and 226a of the server 122. In the illustrated example, the computing device 200 includes a processor 202, a memory 204, a communication unit 208, and a display 218.

In some implementations, the computing device 200 is a client device 106, the memory 204 stores the injection-based attack detector 226b, and the communication unit 208 is communicatively coupled to the network 102 via signal line 114. In some implementations, the computing device 200 is a client device 106, which may occasionally be referred to herein as a user device, and the client device 106 includes at least one sensor, e.g., a camera. In another implementation, the computing device 200 is a server 122, the memory 204 stores the injection-based attack detector 226a, and the communication unit 208 is communicatively coupled to the network 102 via signal line 116.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual and may include a single processing unit or a plurality of processing units and/or cores. In some implementations, the processor 202 may be capable of generating and providing electronic display signals to a display device, supporting the display of images, capturing and transmitting images, and performing complex tasks and determinations. In some implementations, the processor 202 may be coupled to the memory 204 via the bus 206 to access data and instructions therefrom and store data therein. The bus 206 may couple the processor 202 to the other components of the computing device 200 including, for example, the memory 204, the communication unit 208.

The memory 204 may store and provide access to data for the other components of the computing device 200. The memory 204 may be included in a single computing device or distributed among a plurality of computing devices. In some implementations, the memory 204 may store instructions and/or data that may be executed by the processor 202. The instructions and/or data may include code for performing the techniques described herein. For example, in one implementation, the memory 204 may store an instance of the injection-based attack detector 226. The memory 204 is also capable of storing other instructions and data, including, for example, an operating system, hardware drivers, other software applications, databases, etc. The memory 204 may be coupled to the bus 206 for communication with the processor 202 and the other components of the computing device 200.

The memory 204 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 202. In some implementations, the memory 204 may include one or more of volatile memory and non-volatile memory. The memory 204 may be a single device or may include multiple types of devices and configurations.

The communication unit 208 is hardware for receiving and transmitting data by linking the processor 202 to the network 102 and other processing systems. The communication unit 208 receives data and transmits the data via the network 102. The communication unit 208 is coupled to the bus 206. In one implementation, the communication unit 208 may include a port for direct physical connection to the network 102 or to another communication channel. For example, the computing device 200 may be the server 122, and the communication unit 208 may include an RJ45 port or similar port for wired communication with the network 102. In another implementation, the communication unit 208 may include a wireless transceiver (not shown) for exchanging data with the network 102 or any other communication channel using one or more wireless communication methods, such as IEEE 802.11, IEEE 802.16, Bluetooth® or another suitable wireless communication method.

In yet another implementation, the communication unit 208 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another implementation, the communication unit 208 may include a wired port and a wireless transceiver. The communication unit 208 also provides other connections to the network 102 for distribution of files and/or media objects using standard network protocols such as TCP/IP, HTTP, HTTPS, and SMTP as will be understood to those skilled in the art.

The display 218 may include a liquid crystal display (LCD), light emitting diode (LED), touchscreen, or any other similarly equipped display device, screen, or monitor. The display 218 represents any device equipped to display electronic images and data as described herein.

It should be apparent to one skilled in the art that other processors, operating systems, inputs (e.g., keyboard, mouse, one or more sensors, etc.), outputs (e.g., a speaker, display, haptic motor, etc.), and physical configurations are possible and within the scope of the disclosure. Examples of sensors (not shown) include, but are not limited to, a microphone, a speaker, a camera, a thermal camera, a pointer sensor (e.g., a capacitive touchscreen or mouse), a gyroscope, an accelerometer, a galvanic sensor, thermocouple, heart rate monitor, breathing monitor, electroencephalogram (EEG), iris scanner, fingerprint reader, raster scanner, palm print reader, an inertial sensor, global positioning system (GPS) sensor, etc.

In some implementations, the injection-based attack detector 226 provides the features and functionalities described below responsive to a request. For example, a request on behalf of an entity (not shown), such as a financial institution, to determine whether a user-provided document image (e.g., provided during a registration or customer onboarding) is legitimate or potentially fraudulent. As another example, a request may be by the user, such as to capture a document image and/or personal image, such as a selfie (e.g., as part of a registration or customer onboarding).

Depending on the implementation and use case, the injection-based attack detector 226 may have one or more implementations including, but not limited to, an API implementation, a web implementation, and a software development kit (SDK) implementation. In some implementations, the injection-based attack detector 226 is a web implementation and one or more of a verification vendor applying the injection-based attack detector 226 may control the picture taking, multiple frames may be taken, there's opportunity to perform liveness detection, and the verification process is abstracted from the hardware. In some implementations, the injection-based attack detector 226 is an SDK implementation and one or more capture multiple frames, capture frames automatically, leverage liveness detection, be embedded into the phone experience, verification (and the injection-based attack detector 226 or a subcomponent thereof) is operating within the mobile OS, and camera injectors (e.g., virtual cameras, etc.) may be detected, and reduce the amount of fraud attempts to be processed, or processed more extensively, by the system 10.

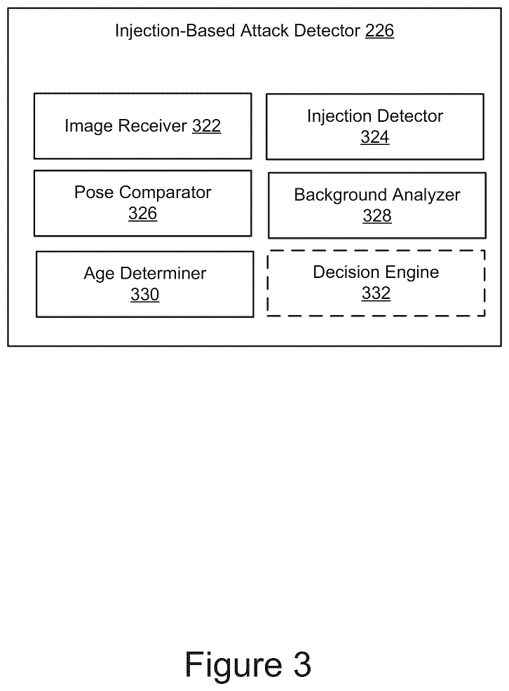

Referring now to FIG. 3, a block diagram of an example of injection-based attack detector 226 is illustrated in accordance with one implementation. As illustrated in FIG. 3, the injection-based attack detector 226 may include an image receiver 322, an injection detector 324, a pose comparator 326, a background analyzer, and, optionally in some implementations, a decision engine 332.

The image receiver 322 is communicatively coupled to receive image data. For example, in some implementations, the image receiver 322 receives image data captured by a camera sensor or injected as though captured by a camera sensor. Examples of image data may include, but are not limited to, one or more of an image and a video. In some implementations, a received image represents a document and a background, or surroundings, of that document. For example, the received image data includes an image received responsive to the user 112 being prompted to take an image of the document. In some implementations, a received image represents a person and a background, or surroundings, of that person. For example, the received image data includes an image received responsive to the user 112 being prompted to take a selfie (e.g., a single image or video clip).

The image data may be “real” or “genuine” (i.e., an un-modified and true representation of the subject matter in the image), altered (e.g., using photoshop or an injection attack), or a combination thereof (e.g., a real document holder image but a modified selfie image or vice versa).

The image receiver 322 makes the received image data available to one or more components of the injection-based attack detector 226. In some implementations, the image receiver 322 communicates the received image to, or stores the received image for retrieval by, one or more other components of the injection-based attack detector 226.

The injection detector 324 determines whether a received image (e.g., a selfie or a document image) is a product of an injection attack. In some implementations, the injection detector 324 may detect usage of a known virtual camera device, and determine the image is an injection attack or increase the likelihood that the image is rejected as an injection attack. For example, the injection detector 324 detects whether an image is from a virtual camera or whether a virtual camera is present, such as ManyCam. In some implementations, the injection detector 324 may determine the resolutions of a selfie and document image (purportedly taken by the same camera to generate the request) differs, and that at least one of those images was, thereby, injected. In some implementations, a customer (e.g., a bank) may change the capture conditions in such a way to be detected in the resultant selfie or document capture (e.g., change in the illumination, resolution, color shift, inclusion of a digital watermark, hash, time and date stamp, etc.), and the injection detector 324 may determine the absence of the expected/valid capture conditions specified and imposed by a customer to be indicative of an injection attack. In some implementations, the injection detector 324 may build and maintain a “block list” of devices with high fraud, or attempted fraud, rates and determine that subsequently received images are, or are more likely to be, a product of an attack.

In some implementations, the injection detector 324 applies a machine learning model to detect any subtle differences (e.g., artifacts) between genuine and fraudulent (e.g., generated using an injection attack or other digital manipulation) images. These differences are often imperceptible to the human eye. In some implementations, the injection detector 324 may train and/or validate one or more injection detection ML models that the injection detector applies.

For example, in some implementations, the injection detector 324 may train a model to compare images for artifacts created by imperfections in the semiconductor associated with the camera and determine whether artifacts associated with those imperfections are present in both the selfie image and the document image indicating that a common camera was used (as expected in a valid/non-fraudulent request) or whether different artifacts are present indicating different cameras were used, which may be indicative of injection and fraud.

Different injection attacks may use different deepfake, face morph, and face swap generative AI techniques, and each technique may create a different set of artifacts. Depending on the implementation, the injection detector 324 may train individual models, e.g., an individual model for each of the various injection attack techniques (e.g., deepfake, face morph, and face swap generative AI techniques) or may train a model for a combination of multiple injection techniques. In some implementations, the injection detector 324 may use different sets of images for training individual models. For example, in some implementations, the injection detector 324 may include synthetically generated images of people specific to the type of injection attack in the training set. For example, the injection detector 324 may collect or generate face swaps for use in a training set used to detect face swaps (or artifacts associated therewith) and/or a set of completely synthetically generated faces for use in a training set used to detect completely synthetic faces (or artifacts associated therewith). Additionally, it should be recognized that multiple methods exist for each type of attack (i.e., there are different methods to achieve a face swap and different methods for generating a synthetic face and different methods of morphing a face). In some implementations, the training set and the model trained may be method-specific to one of those particular methods (e.g., face morph using X method model) or may be trained on an image set including a variety of methods associated with an attack to be attack-type specific (e.g., face morph detection model). It should be noted that while face swap and face morph are described with reference to generative AI techniques, they may not necessarily rely on a generative AI method, and the functionality and features described herein may generate one or more models to detect artifact(s) associated with those other techniques.

The artifacts detected may vary based on one or more of the implementations, use case, attack type, and technique. Examples include, but are not limited to unnatural eye movement; absence of expected movement or expression change in the remainder of the face; anomalies or asynchronies between ear and jaw movements; etc. It should be recognized that some artifacts may not be perceptible to the human eye. For example, assume that when performing a face swap, the ears are unchanged and there is a slight lag in the jaw as the face swap software maps the mouth and jaw of the document holder image face to the live actor/nefarious user's jaw. In some implementations, the injection detector 324 may identify the slight asynchrony between ear movement and jaw movement that is imperceptible to the human eye.

In some implementations, the injection detector 324 trains an injection detection model based on a training set of images (document, selfie, or a combination thereof) including images generated using an array of popular open-source deepfake/face swap/face morph/generative AI techniques including GAN-based synthetic faces, diffusion model-based synthetic faces, and auto-encoder-based methods. In some implementations, the training set may not include any production injected images (e.g., deepfakes submitted by nefarious users to defeat a verification process), at least initially. In some implementations, the injection detector may be retrained or use reinforced learning based on images, including deepfakes, face swaps, face morphs, etc., that are encountered in production to improve performance and/or adapt as injection attack technology advances.

In some implementations, the injection detector 324 applies data augmentation to bolster the training data set. For example, the injection detector 324 applies one or more of an induced blurriness and JPEG compression.

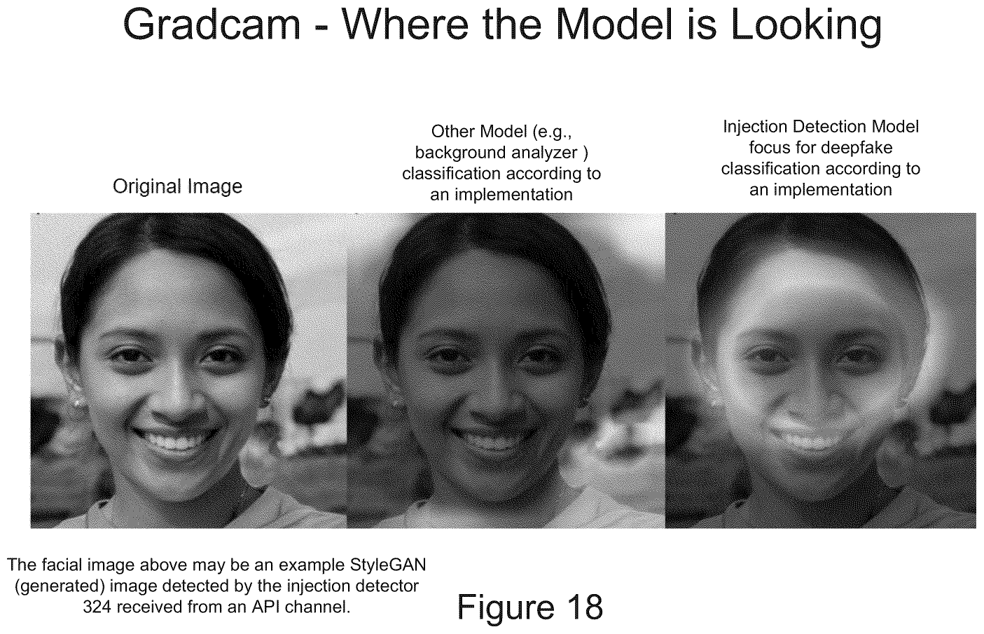

In some implementations, the injection detector 324 uses a single frame (e.g., a single still image submitted by the user or a single frame from a selfie that's video). In some implementations, the injection detector 324 applies facial detection. In some implementations, the facial detection is used in training the injection detection model, so the model concentrates on the facial features and/or immediately surrounding area, which may be where artifacts from injection are most likely to be present. Referring now to FIG. 18, a set of images shows the area of focus for the injection detection model(s) trained and used herein in accordance with some implementations. In the illustrated implementation, a deepfake detection model focuses on the region of the selfie with the face, more specifically, the eyes, as this may be where model determines artifacts associated with deepfakes may be present and/or are detected. Other models, such as a background analyzer model may focus on the background/surroundings.

The injection detector 324 may train the one or more injection detection models using a variety of machine learning techniques, depending on the implementation and use case, including supervised learning, unsupervised learning, semi-supervised learning, etc. The varieties of supervised, semi-supervised, and unsupervised machine learning algorithms that may be used, by the injection detector 324, to train the one or more injection detection models are so numerous as to defy a complete list. Example algorithms include, but are not limited to, a decision tree; a gradient boosted tree; boosted stumps; a random forest; a support vector machine; a neural network; a recurrent neural network; a recurrent neural network; deep learning; long short-term memory; transformer; logistic regression (with regularization), linear regression (with regularization); stacking; a Markov model; Markov chain; support vector machines; and others.

In some implementations, the injection detector 324 may train an injection detection model that is a binary classifier. For example, the injection detector 324 trains multiple binary classifier models using backbone networks like ResNet-34 or EfficientNet and the injection detector 324 applies the best performing binary classifier (as determined during validation) in production. In production, the injection detection model will be applied to image data provided by users (e.g., customers during an onboarding process) responsive to a request (e.g., for verification). In some implementations, the injection detector 324 may apply an ensemble method, e.g., by collating the inference results from multiple models to reach a conclusion.

It should be recognized that, while the foregoing example uses a binary classifier (i.e., two classes—one class associated with the presence of injection and the other class associated with an absence of injection), depending on the implementation more and/or different classes may be present. For example, in some implementations an “inconclusive” class may be present. It should further be recognized that while classification is described above, in some implementations, the injection detector 324 may apply a regression model to predict a numerical or continuous value, such as a probability that injection is present.

The pose comparator 326 determines and compares a pose between multiple images. Assume that a request is associated with a first received input image that is a picture of a document with a document holder image (e.g., a picture ID) and a second received input image that is a selfie. Also assume that the person in the document holder image and selfie need to match (i.e., the facial features need to be sufficiently similar to likely represent the same person) otherwise the request is rejected (e.g., as fraudulent). However, too close/perfect of a match may be indicative of reproduction and, therefore, fraud. In some implementations, the pose comparator 326 determines and compares a pose between a document holder image (e.g., from a document image) and a facial image (e.g., from a selfie or video that may also be used for liveness detection).

The pose comparator 326 receives image data, determines the pose (e.g., applies pose estimation) to each of the images to be compared, and compares the poses. For example, the pose comparator 326 receives a set of associated images (e.g., responsive to a verification request that includes a selfie image and a document image), determines the pose of the document holder's facial image (e.g., based on key points associated with various facial features), determines the pose of the face in the selfie, and compares the document holder pose to the selfie image pose. In a valid instance it is very unlikely, near impossible, that the user's pose (e.g., the pitch, roll, and yaw of the head or face and/or a facial expression) in the selfie would reproduce (i.e., be identical or nearly identical) the user's pose in the user's own document holder image. The pose comparator 326 compares the poses and determines whether the pose between images satisfies a similarity threshold. The similarity threshold, when satisfied, may be indicative that the poses are sufficiently similar or “suspiciously similar,” which may be indicative of fraud. In some implementations, there may be multiple thresholds. For example, a first threshold of high pose similarity when satisfied may be associated with and indicative of fraud, a second threshold of moderate pose similarity, when satisfied may be associated with and indicative of inconclusiveness, and when neither the first or second threshold are satisfied it may be indicative of validity or an absence of fraud. The number of thresholds, or classification, may vary, e.g., in some implementations, there may be a single threshold (or two classes—one indicative of a suspiciously high pose similarity and another associated with non-suspicious pose similarity). In some implementations, the threshold(s) or classes may be determined using machine learning. For example, a classifier is trained to classify pairs of images (e.g., document image and selfie) into suspicious and non-suspicious classes based at least in part on their pose similarity score. In some implementations, the degree of similarity that qualifies as suspicious may be modified to reduce false negatives or to reduce false positives.

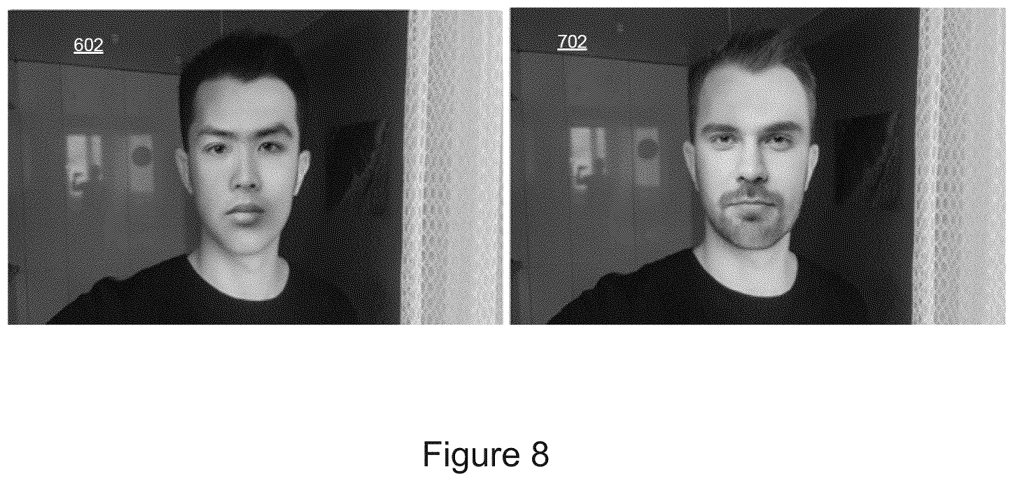

Referring to FIGS. 4, 5, 6, 7, and 9, the pose between the document holder images 406/506/606/706/906 and their corresponding selfies 402/502/602/702/902, respectively, is identical. Referring now to FIG. 8, while the selfies 602 and 702 were submitted in separate requests and purport to be of different document holders, the pose (e.g., of the face including or excluding the shoulders) is similar, perhaps identical. In some implementations, the pose comparator 326 may compare and identify similarities in pose between images associated with a single request (e.g., between 502 and 506 in FIG. 5) and/or between images across requests associated with one or more of different document holder information, different document holders, and different users (e.g., between images 602 and 702 as shown in FIG. 8).

In some implementations, the pose comparator 326 may determine and store the pose associated with incoming images (e.g., in a pose database). Depending on the implementation, the poses associated with document holder images, selfie captures, or both may be stored. Depending on the implementation, the poses associated with incoming requests or requests identified as fraudulent may be stored. In some implementations, the pose comparator 326 determines a pose associated with an incoming image and compares that to the poses associated with previously received images. To summarize and simplify, depending on the implementation, the pose comparator 326 may compare poses (1) between images associated with a single request (e.g., selfie pose to document holder pose associated with a common request), (2) between images associated with different requests (e.g., a pose in a selfie associated with a pending request to the pose in selfies associated with prior requests rejected by the injection-based attack detector 226 as fraudulent), or (3) both.

In some implementations, the pose comparator 326 applies pose estimation. For example, the pose comparator 326 applies one or more of a 2D, 3D, top-down approach, or bottom-up approach, to determine a pose in the input image. In some implementations, the pose comparator 326 uses homography estimation to determine and compare poses between images (e.g., between the selfie and document holder image, between two selfies, etc., depending on the use case and type of attack). While homography is typically used to map a facial image captured in the wild (e.g., from an angle or profile and not from straight on, as in a picture ID) to frontal face image (e.g., frontal face pictures, such as those in a DMV database), in some implementations, the pose comparator 326 may determine whether one image is the result of a homography transformation of another. For example, referring to FIG. 8, the pose estimation of selfie 602 and 702 may be (nearly) identical, but a more sophisticated attack may apply a homography transformation to change the pose (e.g., tilt or rotate the head and face) between photos. In such a scenario, the degree of pose manipulation may be such that the pose comparator 326, using pose estimation, may not determine that the two images are suspiciously similar, but the pose estimator 326, when using homography estimation, may determine that the poses are suspiciously similar, as one is a homographic transform.

Depending on the implementations, the pose comparator 326 may apply pose estimation, homography estimation, or both. In some implementations, the pose comparator 326 may perform multiple estimations in series in series or in parallel.

The background analyzer 328 is communicatively coupled to obtain image data, as an input, separate the background/surroundings from the subject of the image, and determine whether the background is indicative of fraud. In some implementations, the background analyzer 328 receives image data, such as an image or video of a document or person (e.g., a selfie) captured by the client device's camera sensor or submitted via an API channel during a customer journey. In some implementations, the background analyzer 328 receives other image data. Examples of other image data may include, but is not limited to, images or videos of documents or selfies captured by other client devices' camera sensors or submitted via an API channel during other (e.g., past) customer journeys, images or videos of documents identified to be fraudulent or associated with fraudulent attempts (e.g., fraudulent attempts to open an account, etc.), images or videos associated with a reference document (e.g., an image representing an example ID posted on the ID issuer's website), etc.

The background analyzer 328 processes image data. The processing steps and their respective order may vary depending on the implementation. In some implementations, the background analyzer 328 processes image data by performing one or more of rectification, segmentation, and transformation.

In some implementations, the background analyzer 328 separates the image into a background portion representing a subject's surroundings and a subject portion representing a subject of the image, such as a person or document. In some implementations or use cases, the subject portion may be the portion of the image representing the document, occasionally referred to herein as a “document portion” or similar, when the image is of a document. For example, in some implementations, the background analyzer 328 applies corner detection to identify the corners of the pictured document and determines a document portion to be the portion of the input image bounded within the identified corners and determines a background portion to be the portion of the input image out of bounds of the identified document corners. In some implementations, the subject portion may be the portion of the image representing a person (e.g., the portion including the face, head, or portion outlined by the person's silhouette, which may include the user's hair, face, neck, and shoulders) where the image is a selfie of a person. For example, the background analyzer 328 may apply edge detection or other computer vision techniques to outline one or more of the face, head, and user's silhouette.

The portion(s) considered to be background may vary depending on the implementation and use case. For example, in some implementations, the user's injection attack may only alter the user's facial features in a selfie so the user's shoulders, clothing, and possibly hair and/or ears may be consistent between images of fraudulent attempts, and inclusion of the shoulders in the background portion may help, or at least not hinder, subsequent analysis. In some implementations or use cases, the shoulders may be excluded from the background portion. As another example, in some implementations, nefarious users may only alter PII and the document holder image on documents. Accordingly, portions of the ID that are invariant (i.e., that do not vary between valid instances of the same type and version of a document) may be included in the background portion of a document image.

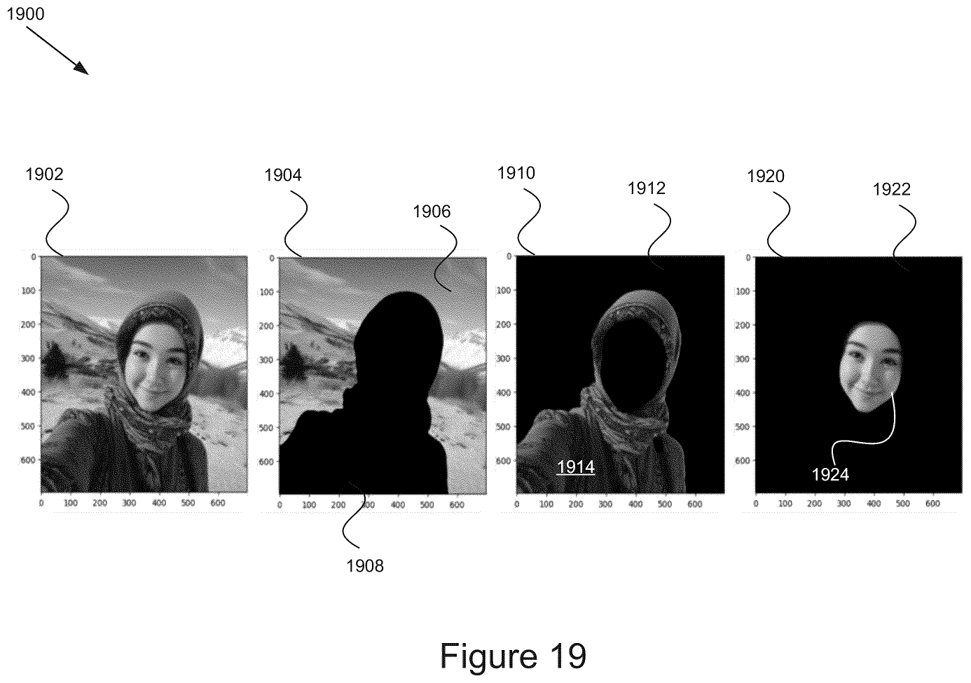

In some implementations, the background analyzer 328 may segment the image data or a portion thereof. For example, the background portion of the image may have an irregular shape due to a void (e.g., in the center) where the subject (e.g., document or person's face) was represented; in some implementation, the image preprocessor 324 may segment the background into a plurality of segments. For example, referring now to FIG. 19, an example of segmentation of an image 1902 into a background segment 1906, body segment 1914, and a face segment 1924 is shown. It should be understood that any number of different segments may be applied to a given image. In one example, the background analyzer 328 includes a media pipe selfie segmenter. Based on the attributes of fraudulent images that have been submitted, those images can be analyzed to determine which segments are repeatedly used with a high frequency of similarity. As another example, when the image being segmented is that of a rectangular document, in some implementations, the background portion, analogous to 1906 in FIG. 19, is that has an outer rectangular boundary (i.e., the outer bounds of the image) and an inner boundary (i.e., boundary outlining the document as the subject, which may be analogous to the outline of the body/silhouette in 1914 or face 1924 segments in FIG. 19). The background analyzer 328 segments the background portion into multiple segments, which the background analyzer 328 may compare to other image segments. In some implementations, the background analyzer 328 accesses a database (e.g., a document database) which contains previously seen fraudulent documents and selfies and compares incoming segmented images to prior fraudulent segments.

The background analyzer 328 compares background portion, or one or more segments thereof, generated from one input image to those generated from prior input images and determines whether a match exists. In some implementations, a match exists when a threshold similarity is satisfied. When a match between the background portion (or segment thereof) from an image under test and a previously received background portion (or segment thereof) the existence of a match may be indicative of fraud. For example, it may be indicative that the request and/or input image presently under test is fraudulent, particularly when the previously received background portion (or segment thereof) is associated with a previous request marked as fraudulent. As another example, it may be indicative that the prior request even if not flagged as fraudulent may have in fact been fraudulent and remedial action should be taken (e.g., re-evaluation, reclassification as fraudulent, reported to an authority, etc.). The similarity may be a biproduct of nefarious users often making repeated, fraudulent attempts until they achieve some success. For example, they may take an image of a valid document instance and repeatedly overlay different (fraudulent) personally identifiable information (PII) in successive requests. As another example, they may take the document holder's image and inject (e.g., by overlaying the document holder's face or morphing their face to be more similar to the document holder's) in a selfie image using multiple valid documents (e.g., found on the dark web). When such repeated, or bulk, attempts are made, the background is often similar. As another example, the user may be making the images for the repeated attempts serially, so the user's background/surroundings (which may include clothing) remains relatively constant as he/she injects a first cardholder's face onto his/her own face in a selfie, then injects a second cardholder's face onto his/her own face in a second selfie, and so on. The nefarious user may be modifying a single image serially neglecting the background or only make relatively minor adjustments. For example, the user injects a first cardholder's face onto a selfie base image to make a first fraudulent selfie, then injects a second cardholder's face onto his/her onto that same selfie to make a second fraudulent selfie image, and so on, but before submitting the selfie as part of a request, the nefarious user crops the various selfie images slightly differently, which may result in one or more of a difference in resolution, zoom, rotation, and translation in the input image.

In some implementations, the background analyzer 328 applies a transformation to the background portion or at least one segment of the background portion as part of the analysis. For example, in some implementations, the background analyzer 328 applies one or more of a translation, rotation, and magnification of the background portion or a segment thereof. Analysis of the background may capture fraudsters that are taking images with a similar background or editing an image of a document with a static background, even when the nefarious user makes modifications (e.g., to the resolution of the input image, by changing the level of zoom and frame angle on an image of a document, etc.) so that the backgrounds are not completely identical between attempts.

In some implementations, the background analyzer 328 determines a signature associated with one or more of a portion of an image or segment thereof. In some implementations, a raw, input/received, image may be associated with one or more signatures. For example, the multiple signatures may include one or more signatures determined for the background portion (or for one or more of the segments thereof) and one or more signatures of a subject portion (or one or more segments thereof).

Depending on the implementation and use case, the signature may vary. For example, in some implementations, the background analyzer 328 determines a signature based on one or more hashes. For example, the background analyzer 328 determines a signature based on one or more of an average hash, a perceptual hash, a difference hash, and a wavelet hash. In some implementations, the background analyzer 328 determines a signature based on a composite of multiple hashes. For example, in some implementations, the background analyzer 328 determines a signature based on two or more of an average hash, a perceptual hash, a difference hash, and a wavelet hash by determining the two or more hashes and concatenating the two or more hashes to generate the signature. For example, assume the average hash is 1000, the perceptual hash is 1111, the difference hash is 0100, and the wavelet hash is 0001, the signature determiner 326 determines a signature as 1000111101000001 by concatenating the four aforementioned hashes associated with the received image (or a portion thereof, depending on the implementation). It should be recognized that the preceding example hashes are simplified hashes used for clarity and convenience and may not be representative of hashes in implementation. It should further be recognized that the preceding is merely an example of a composite hash and that variations in the manner of composition (e.g., other than concatenation), the number of hashes composited (e.g., 1, 2, 3, 4, etc.), and relative order of composition (e.g., the hashes may be concatenated in other orders) are contemplated and within the scope of the present disclosure. In some implementations, the signature may be based on machine learning. For example, in some implementations, an image is input to a neural network, such as a convolutional neural network, and the resulting encoding of the image is the signature.

In some implementations, the background analyzer 328 obtains information associated with one or more other images. In some implementations, the background analyzer 328 obtains other image information (e.g., information such as signature(s) associated with images associated with prior verification requests) that is used by the background analyzer 328 to determine a similarity between the received image and the one or more other images.

In some implementations, the other image info may include information derived from previously received images. The other image information may vary based on the implementation and use case. Examples of other image info include, but are not limited to, other images or segments thereof, hash(es) associated with another image (such as hashes for or one or more portions or segments thereof), signature(s) associated with another image (such as signatures for one or more portions or segments thereof), one or more labels, such as document type, associated with another image, etc.

The document type may vary based on the implementation and use case. In some implementations, the document type may include a type associated with identification documentation. Examples of types associated with identification documentation include, but are not limited to a passport, driver's license, government issued photo identification card, school identification, employee identification, etc. In some implementations the document type label may include an issuer of the identification document type. Examples of issuers include, but are not limited to a country, state, province, municipality, jurisdiction, school, business, employer, or other entity. For example, a label associated with a US passport image may include a passport, documentation type label component, and a US, issuer label component.

In some implementations, the background analyzer 328 accesses the other image information. For example, the background analyzer 328 accesses the other image information, without filtration, and the background analyzer 328 processes the other image information to determine whether a similarity exists.

In some implementations, the background analyzer 328 filters the other image information. For example, the background analyzer 328 filters the other image information to reduce subsequent processing requirement of the background analyzer 328. For example, in some implementations, the background analyzer 328 may calculate a hamming distance between a signature associated with an input image (e.g., concatenated hashes associated with a background portion of the received image) and a corresponding signature associated with other images (e.g., the concatenated hashes associated with a background of the other images). In some implementations, once the hamming distance between the signature of input image and the other images are determined, the other image information retriever 328 determines a subset of the other images with the smallest hamming distance. For example, the background analyzer 328 determines the X other images with the smallest hamming distance, where X may be in the 10s, 100s, or 1000s depending on the implementation.

In some implementations, the background analyzer 328 determines a similarity between signatures associated with different images. In some implementations, the background analyzer 328 determines the similarity between a signature associated with a received image and a corresponding signature associated with one of the other images.

Depending on the implementation, the background analyzer 328 may apply one or more of cosine similarity (one dimensional or two dimensional), dot product, and Euclidean distance. For example, the background analyzer 328 determines the cosine similarity of the concatenated hashes associated with a document portion of a received image to the concatenated hashes of document portions of other images and determines whether a similarity exists. The preceding example is merely an example, it should be recognized that, as described herein, the signature may vary depending on the implementation (e.g., the number, types of hashes, order of hashed, be an encoding of various formats output by a neural network, etc.), and while, for brevity, a dedicated example of determining similarity for each potential signature is not described here, those variations are within the scope of this disclosure. Similarly, as described herein, the preprocessed image and/or portions, or segments, of the preprocessed image used to generate a signature and subsequently used to determine similarity may vary depending on the implementation (e.g., to include one or more of a document portion, at least one segment thereof, a background portion, and at least one segment thereof), but for brevity, a dedicated example of each potential variation of what portion, or segment(s) associated with an image are analyzed for similarity is not described here; however, those variations are within the scope of this disclosure. Similarly, as described herein, various similarity determinations besides cosine similarity are described, but for brevity, a dedicated example of each is not described here; however, those variations are within the scope of this disclosure.

In some implementations, the similarity may be associated with a threshold. For example, when the cosine similarity satisfies the threshold, similarity exists, and when the cosine similarity threshold is not satisfied, a similarity does not exist.

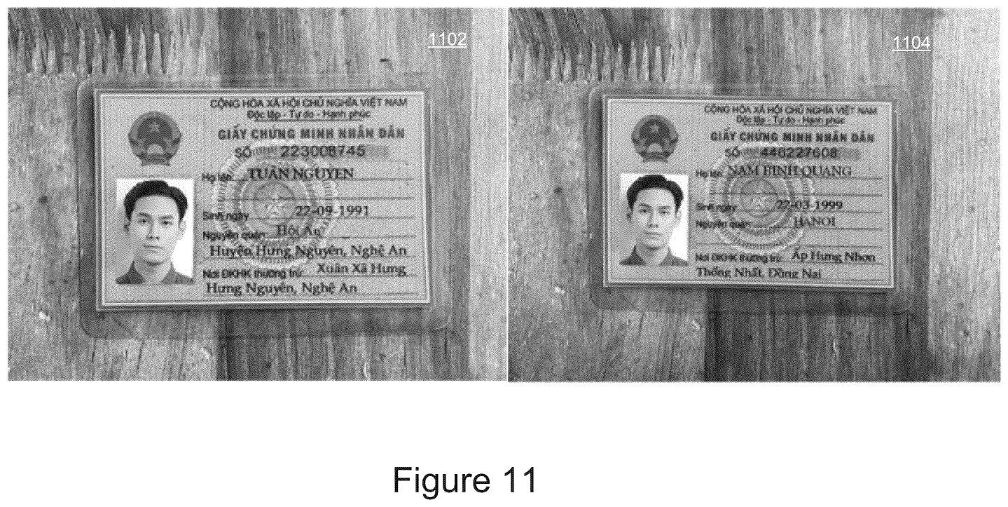

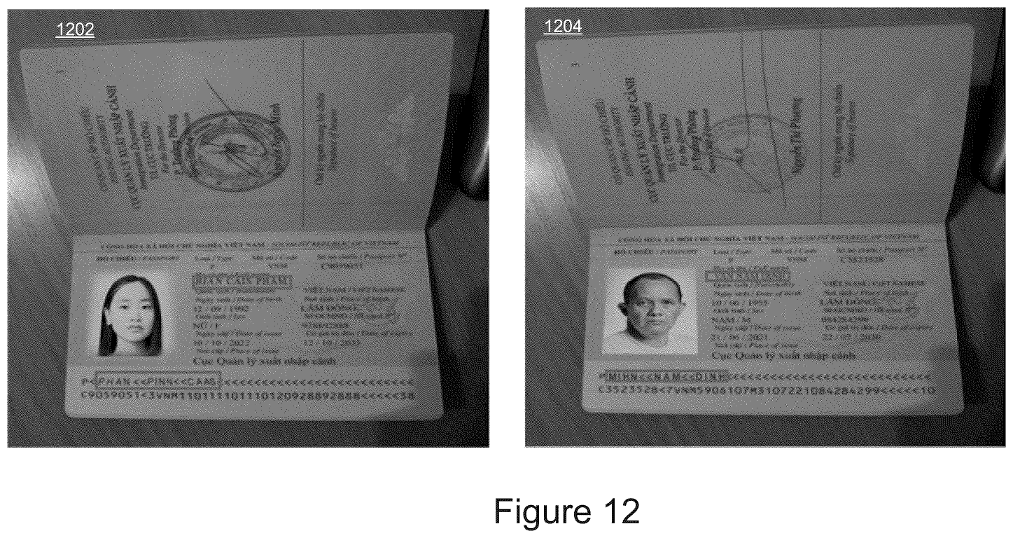

In some implementations, the background analyzer 328 may analyze the background associated with a document image. For example, the background analyzer 328 may compare image document image 404 of FIG. 4 to document image 504 of FIG. 5, and determine the backgrounds are substantially similar. As another example, the background analyzer 328 may compare the document images 604 of FIG. 6 to 704 of FIG. 7, or document images 1102 and 1104 of FIG. 11, or 1202 and 1204 of FIG. 12, and find that the backgrounds are similar (but not identical) or identical despite receiving the document images in separate requests and identifying and purportedly being associated with different document holders and/or users.

In some implementations, the background analyzer 328 may analyze the background associated with a selfie image or video. For example, the background analyzer 328 may compare the selfie image 602 of FIG. 6 to selfie image 702 of FIG. 7, which are shown side-by-side in FIG. 8, and determine the backgrounds are substantially similar.

The age determiner 330 is coupled to obtain image data as an input and determine whether an age discrepancy exists. The image data may include one or more of a selfie image (or video) and a document image. Depending on the implementation, the age determiner 330 may determine one or more types of age discrepancies. Examples of age discrepancy types that may be detected include, but are not limited to, one or more of (1) determining that the age of the face in the selfie image exceeds the age of the face in the document holder image, (2) determining that the age of the face in the selfie holder image is less than the age indicated by a date of birth in the document image, and (3) that the issue date precedes the date of birth in the document.

In some implementations, the age determiner 330 applies one or more machine learning models to determine whether an age discrepancy exists. For example, the age determiner 330 applies a first model to determine the age of a face in an image. The determined ages of a selfie and a document holder image may then be compared by the age determiner 330 to determine the first type and/or second type of age discrepancy. In another example, the age determiner 330 applies a second model (e.g., using a classifier to determine the document type and object detection or character recognition) to determine the issue date and date of birth, which may be used to determine the third type of age discrepancy (or inform the first and second type of age discrepancy by accounting for the amount of time that has passed between the document issuance, as a proxy for the date the document holder image was taken, and the current date or date of the request, which is purported to be when the selfie image was taken.

Depending on the implementation, the age determiner 330 may apply a pre-trained model or may apply a model that the age determiner 330 trains, validates, and retrains. For example, in some implementations, the age determiner 330 applies a pretrained model to determine the age of a face in an image. In some implementations, the age determiner trains, validates, and retrains a model. For example, in some implementations, the age determiner 330 may train a model to determine when an age discrepancy that is suspicious or indicative of fraud exists. In some implementations, the age determination models may be trained using different real people or/and synthetically generated images of people of different ages, gender, and ethnicity.

The varieties of supervised, semi-supervised, and unsupervised machine learning algorithms that may be used, by the age determiner 330, to train the one or more age determination models are so numerous as to defy a complete list. Example algorithms include, but are not limited to, a decision tree; a gradient boosted tree; boosted stumps; a random forest; a support vector machine; a neural network; a recurrent neural network; a recurrent neural network; deep learning; long short-term memory; transformer; logistic regression (with regularization), linear regression (with regularization); stacking; a Markov model; Markov chain; support vector machines; and others.

In some implementations, the age determiner 330 may determine one or more thresholds associated with different types of age discrepancies. In some implementations, the age determiner 330 determines an age difference threshold for the difference in determined ages of the selfie face and the document holder image face. Stated differently, the age determiner 330 determines how much older the face in the document holder image must be compared to the face in the selfie image before an age discrepancy is considered to exist. In some implementations, the threshold may be based on an accuracy of the age determination model. For example, assume that the age determination model can estimate the age of a face within 2.5 years of the actual age of the person imaged; in some implementations, the threshold may be a fraction or multiple of the 2.5 years. In some implementations, the threshold may be based on a risk tolerance (e.g., a number of acceptable false positives or false negatives). For example, assume again that the age estimation is accurate within 2.5 years of the actual age. Also, assume that a customer is highly adverse to false positives and risk rejecting a request associated with a valid user. In some implementations, the age determiner 330 may apply a 5-year threshold. In such an example, even if the age determiner model estimated the document holder face to be 2.5 years older than actual and the selfie image to be 2.5 years younger than actual and the document had just been issued so no appreciable aging between document issuance and the date of the request and selfie is expected, the age determiner may not determine an age discrepancy. In some implementations, the threshold(s) may be age determiner 330 determined and set via machine learning or statistics means to mazimize one or more of true-positives, false-negative and/or minimize one or more of fale-positives and true-negatives.

In some implementations, the age determiner 330 may factor in the difference between the issue date and the date of the request or selfie image. For example, when the document image indicates the document was issued 3 years ago, three years is added to the determined age of the document holder image and that revised age is compared to the determined age of the face in the selfie.

In some implementations, one or more thresholds may be applied. For example, a first threshold may be applied to be reasonably certain that the person in the selfie is not younger than the person document holder, which violates the typical chronology of events, and a second threshold may be applied to be reasonably certain that the person in the selfie is not significantly older, as defined by the threshold, than the document holder is expected to be. Depending on the implementation, these determinations may be based on a comparison of the determined age of the face in the selfie to one or more of (1) the age based on the date of birth in the document, (2) the determined age of the face in the document holder image plus the amount of time that has lapsed between the request and the document issue date, or (3) both.

The decision engine 332 makes a decision as to whether the image(s) are associated with an injection-based attack. In some implementations, the decision engine 332 determines and/or initiates an action based on the decision. Examples of actions include, but are not limited to one or more of accept the request or reject the request as fraudulent, contact authorities, escalate for investigation or for additional verification checks, etc.

In some implementations, the decision engine 332 is optional. For example, in some implementations, an injection detection by the injection detector 324, a suspiciously similar pose determined by the pose comparator 326, a suspiciously similar background (or segment(s) thereof), or an age discrepancy determined by the age determiner 330 may individually be definitive/sufficient to determine the presence of fraud (e.g., in the form of an injection-based attack) and their absence may be indicative of a lack of fraud. However, in some implementations, the decision engine 332 may evaluate the combined outputs of two or more of the injection detector 324, the pose comparator 326, the background analyzer 328, and age determiner 330 to determine whether fraud (e.g., in the form of an injection-based attack) is present. In such implementations, the whole may be greater than the sum of its parts in that the decision engine 332 may be able to more accurately predict the presence or absence of fraud based on a combination of outputs from two or more of the injection detector 324, the pose comparator 326, and the background analyzer 328. For example, in cases where the image(s) may have passed each of the individual evaluations (e.g., injection unlikely, no suspiciously similar pose, and no suspiciously similar background) but barely (e.g., the similarity scores were near the thresholds), the decision engine 332 may use the cumulative results/outputs to determine that an injection-based attack may be present and reject the request or subject the request to additional layers of scrutiny. As another example, assume that the injection detector 324 produces false positives (i.e., injection where no injection is present), the decision engine 332 may decide that one or more of the degree of dissimilarity of the backgrounds and/or poses overrides the injection detection and decide that no fraud is present.

It should be noted that, while the decision engine 332 is described above as basing its decision(s) on one or more outputs of the injection detector 324, the pose comparator 326, and the background analyzer 328, the decision engine 332 may use other or additional signals not explicitly described herein. For example, the decision engine may check PII with external databases e.g., AAMVA or other government databases, or evaluate other aspects of the input image and its source to determine fraud or validity.

In some implementations, the decision engine 332 uses machine learning, e.g., to determine one or more of the parameters/criteria and/or values used to make which decision(s) may be determined by training machine learning algorithm(s).

### Example Methods

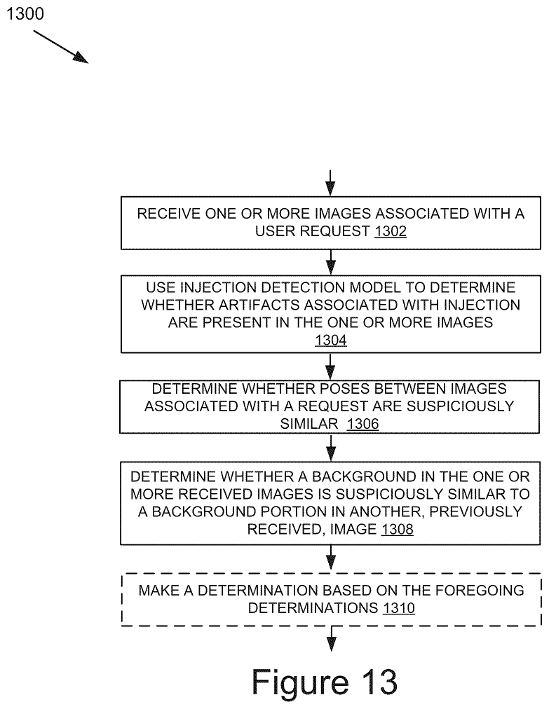

FIGS. 13-15 are flowcharts of example methods that may, in accordance with some implementations, be performed by the systems described above with reference to FIGS. 1-3. The methods 1300, 1306, and 1308 of FIGS. 13-15, respectively, are provided for illustrative purposes, and many variations exist and are within the scope of the disclosure herein. For example, while illustrated as a series in FIG. 13, the determinations 1304, 1306, and 1308 may be performed in parallel. As another example, in some implementations, one or two of the determinations 1304, 1306, and 1308 (rather than all three) may be used to identify an attack or fraud in some implementations. In other words, one or two of the blocks at 1304, 1306, and 1308 in FIG. 13 may be omitted in some implementations. As yet another example, in some implementations, an age discrepancy may be determined instead of, or in addition to, the determinations 1304, 1306, and 1308 of FIG. 13.

FIG. 13 is a flowchart of an example method for injection-based attack detection in accordance with some implementations. At block 1302, the image receiver 322 receives one or more images associated with a user request. At block 1304, the injection detector 324 determines, using an injection detection model, whether artifacts associated with injection are associated with at least one image in the one or more images received at block 1302. At block 1306, the pose comparator 326 determines whether poses between images associated with a request are suspiciously similar. At block 1308, the background analyzer 328 determines whether a background in a received image is suspiciously similar to a background portion in another, previously received, image. At block 1310, which is optional in some implementations, the decision engine 332 makes a determination based on one or more of the determinations at blocks 1304, 1306, and 1308.

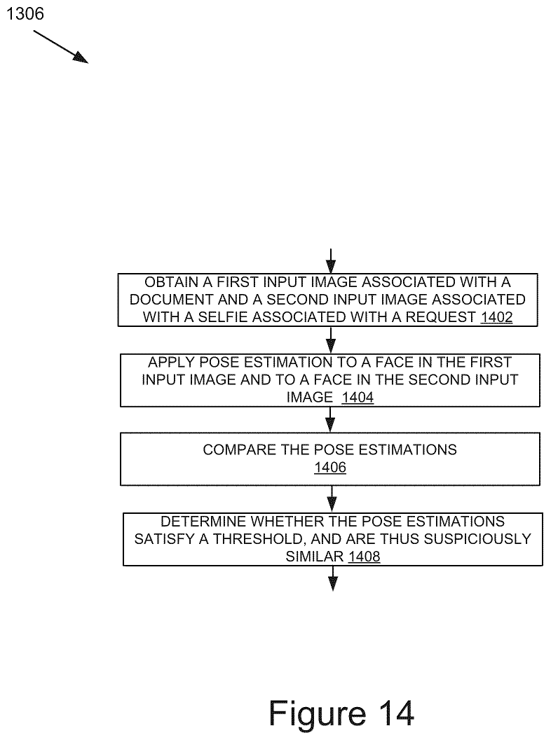

FIG. 14 is a flowchart of an example method 1306 for pose comparison in accordance with some implementations. However, other variations of pose comparison methods exist and are within the scope of this disclosure. For example, while the method 1306 illustrated in FIG. 14 refers to a pose comparison between a document holder image and a selfie that are associated with a common request, it should be recognized that in some implementations and use cases, the pose (whether from the selfie, from the document holder image, or both may be compared to other, previously-received images, such as those (selfies, document holder images, or both) received in association with prior requests or prior requests identified as fraudulent. At block 1402, the pose comparator 326 obtains a first input image associated with a document and a second input image associated with a selfie, where the first input image and second input image are associated with a common request. At block 1404, the pose comparator 326 applies/determines a pose estimation to a face in the first input image and applies a pose estimation to a face in the second input image. At block 1406, the pose comparator 326 compares the pose estimations. At block 1408, the pose comparator 326 determines whether the pose estimations satisfy a threshold and are, therefore, suspiciously similar.

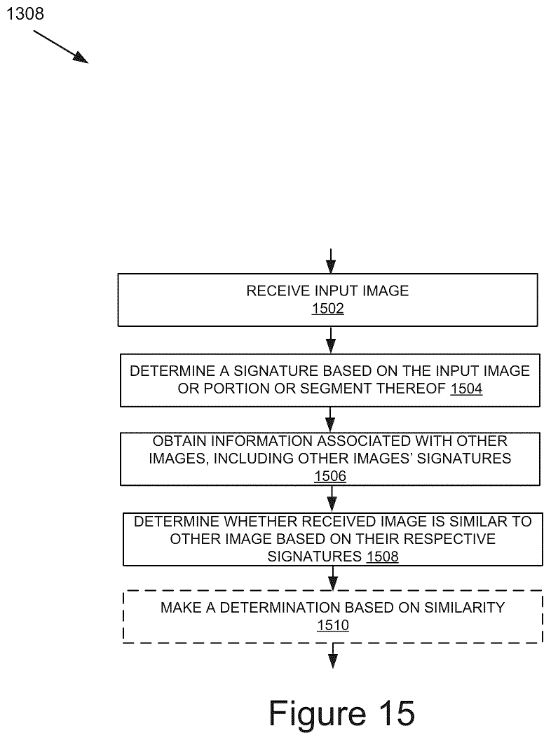

FIG. 15 is a flowchart of an example method 1308 for background analysis in accordance with some implementations. However, other variations of background analysis methods exist and are within the scope of this disclosure. At block 1502, the background analyzer 328 receives an input image. At block 1504, the background analyzer 328 determines a signature based on the input image or a portion or segment thereof. At block 1506, the background analyzer 328 obtains information associated with other images including the signatures of the other images. At block 1508, the background analyzer 328 makes a determination based on similarity (e.g., similarity between the signatures).

### Other Considerations

It should be understood that the above-described examples are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one implementation” or “an implementation” or “some implementations” means that a particular feature, structure, or characteristic described in connection with the implementation is included in at least one implementation. The appearances of the phrase “in some implementations” in various places in the specification are not necessarily all referring to the same implementations.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMS, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer-readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As should be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies, engines, and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
receiving, using one or more processors, one or more images associated with a user request, the one or more images including a first image, wherein the first image includes a facial image purported to be that of a valid document holder;
determining, using the one or more processors, whether artifacts associated with injection are present in the first image;
determining, using the one or more processors, whether a pose in the first image is suspiciously similar to a pose in a second image; and
determining whether a background portion in the first image is suspiciously similar to a background portion in another image, wherein the another image was previously received in association with a prior request, wherein the prior request was associated with different document holder data.

2. The method of claim 1, wherein determining whether artifacts associated with injection are present in the one or more images comprises:
training a first model using images including images using a first type of injection, the first type of injection generating first artifacts, and
determining that first artifacts are present.

3. The method of claim 1, further comprising:
determining, by applying facial detection, a portion of the first image representing a face, wherein the first model focuses on the portion of the first image representing the face.

4. The method of claim 1, wherein first model is injection type specific, the first type of injection is one selected from: a face swap, a face morph, and a synthetic face, and wherein the first artifacts are indicative of the first type of injection.

5. The method of claim 1, wherein determining that the pose in the first image is suspiciously similar to a pose in a second score is based on one or more of a similarity score, a threshold, and a binary classifier.

6. The method of claim 1, wherein the second image is associated with the user request.

7. The method of claim 1, wherein the second image was previously received in association with another user request and associated with different document holder information.

8. The method of claim 1 further comprising:
performing a first pose estimation on a face represented in the first image;
performing a second pose estimation on a face represented in the second image;
comparing the first and second pose estimations; and
determining whether the first and second pose estimations satisfy a threshold indicative of suspicious similarity.

9. The method of claim 1 further comprising:
determining a first signature associated with a background portion in the first image;
determining another signature associated with a background portion in the another image; and
determining, based on the first signature and the another signature, whether the first image and the another image are similar.

10. The method of claim 1, wherein the first signature and the another signature are both based on one or more of an average hash, a perceptual hash, a difference hash, and a wavelet hash.

11. A system comprising:
one or more processors; and
a memory storing instructions that, when executed by the one or more processors, cause the system to:
receive one or more images associated with a user request, the one or more images including a first image, wherein the first image includes a facial image purported to be that of a valid document holder;
determine whether artifacts associated with injection are present in the first image;
determine whether a pose in the first image is suspiciously similar to a pose in a second image; and
determine whether a background portion in the first image is suspiciously similar to a background portion in another image, wherein the another image was previously received in association with a prior request, wherein the prior request was associated with different document holder data.

12. The system of claim 11, wherein determining whether artifacts associated with injection are present in the one or more images comprises:
training a first model using images including images using a first type of injection, the first type of injection generating first artifacts, and
determining that first artifacts are present.

13. The system of claim 11, wherein the instructions cause the one or more processors to:
determine, by applying facial detection, a portion of the first image representing a face, wherein the first model focuses on the portion of the first image representing the face.

14. The system of claim 11, wherein first model is injection type specific, the first type of injection is one selected from: a face swap, a face morph, and a synthetic face, and wherein the first artifacts are indicative of the first type of injection.

15. The system of claim 11, wherein determining that the pose in the first image is suspiciously similar to a pose in a second score is based on one or more of a similarity score, a threshold, and a binary classifier.

16. The system of claim 11, wherein the second image is associated with the user request.

17. The system of claim 11, wherein the second image was previously received in association with another user request and associated with different document holder information.

18. The system of claim 11, wherein the instructions cause the one or more processors to:
perform a first pose estimation on a face represented in the first image;
perform a second pose estimation on a face represented in the second image;
compare the first and second pose estimations; and
determine whether the first and second pose estimations satisfy a threshold indicative of suspicious similarity.

19. The system of claim 11, wherein the instructions cause the one or more processors to:
determine a first signature associated with a background portion in the first image;
determine another signature associated with a background portion in the another image; and
determine, based on the first signature and the another signature, whether the first image and the another image are similar.

20. The system of claim 11, wherein the first signature and the another signature are both based on one or more of an average hash, a perceptual hash, a difference hash, and a wavelet hash.
